(19) United States
(12) Patent Application Publication
(10) Pub. No.: US 2009/0145505 A1
(43) Pub. Date: Jun. 11, 2009

(54) Apparatus to keep compressor lines from freezing-up during cold weather

(76) Inventor: Chad Prysock, Milan, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/953,619

(22) Filed: Dec. 10, 2007

(51) Int. Cl. F16L 9/00

(52) U.S. Cl. 138/109; 138/DIG. 8; 15/313; 15/236.02; 15/401; 15/405; 239/129

(57) ABSTRACT

A system and method of use solves problems associated with air component freeze-up on compressors during winter months. The apparatus includes a length of tubing having an inlet end and an outlet end, a fastener for coupling the tubing to the muffler such that the inlet end is in alignment with the exhaust port of the gas engine associated with the compressor, and a fastener for maintaining the outlet end directed to the air valves or other sections of the compressor to keep them warm and to prevent them from freezing. In a preferred embodiment, brackets are used at the inlet end to accommodate different types of mufflers, and at least a part of the tubing is made up of flexible material, also to accommodate different styles of compressor units. A hook or wire is provided at the outlet end to conveniently direct the hot exhaust gases to the regulator valve or other sections of the compressor that might require heat to keep from freezing up.

### FIELD OF THE INVENTION

This invention relates generally to air-compressors and, in particular, to apparatus that may be installed onto an air-compressor to keep valves and other components from freezing during cold weather.

### BACKGROUND OF THE INVENTION

Those that use air-compressors out-of-doors understand that, during cold winter months, the air lines and/or other components associated with the air lines can freeze-up, requiring considerable down time to address such situations. The problem arises from the fact that moisture collects in the compressed air and, particularly through smaller orifices associated with valves, and the like, in sub-freezing weather, these components can freeze. The result is significant time loss on the job.

### SUMMARY OF THE INVENTION

This invention solves problems associated with air component freeze-up on compressors during winter months by providing a length of tubing having an inlet end and an outlet end, a fastener for coupling the tubing to the muffler such that the inlet end is in alignment with the exhaust port of the gas engine associated with the compressor, and a fastener for maintaining the outlet end directed to the air valves or other sections of the compressor to keep them warm and to prevent them from freezing.

In a preferred embodiment, brackets are used at the inlet end to accommodate different types of mufflers, and at least a part of the tubing is made up of flexible material, also to accommodate different styles of compressor units. A hook or wire is provided at the outlet end to conveniently direct the hot exhaust gases to the regulator valve or other sections of the compressor that might require heat to keep from freezing up.

### BRIEF DESCRIPTION OF THE DRAWINGS

FIG. 1 is a drawing from an oblique perspective showing a typical compressor in a preferred embodiment of the invention prior to installation;

FIG. 2 is a more detailed drawing of the preferred embodiment of the invention, showing brackets and flexible sections; and

FIG. 3 shows the invention mounted on a compressor from the perspective different from that of FIG. 1, illustrating how hot exhaust gases are directed onto a regulator valve.

### DETAILED DESCRIPTION OF THE INVENTION

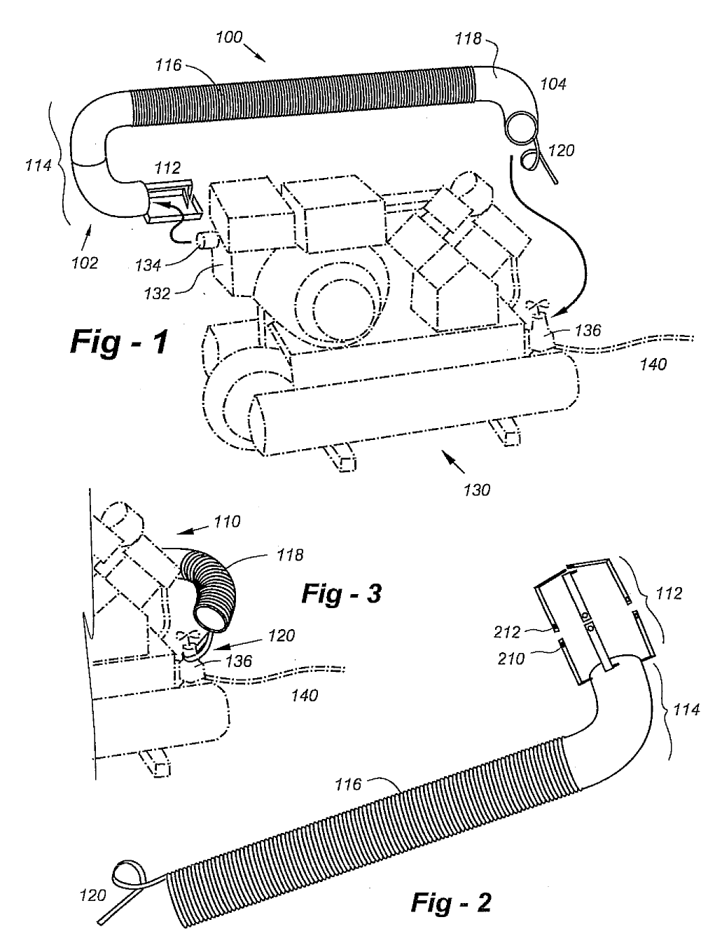

Referring now to the drawings, FIG. 1 is a perspective drawing showing a typical compressor 130 having air tanks and a gas engine with a muffler 132 and exhaust port 134. The compressor also has a regulator valve and other components connected to air line 140, indicated at 136, though not visible in this view.

A preferred embodiment of the invention is shown generally at 100, which includes a length of pipe or tubing having an inlet end 102 and an outlet end 104. The inlet end is coupled to the compressor such that it is in alignment with the exhaust port 134, whereas the outlet end is directed onto components that would benefit from warming during cold weather to keep them from freezing. A typical configuration is shown in FIG. 3, and discussed further below.

The apparatus 100 preferably includes straps or brackets 112 allowing the inlet end 102 to be fastened over the muffler 132 of the compressor 130 to keep it in position. Although typical compressors include a muffler which is more or less square or rectangular in shape, the invention is not limited in this regard, and suitable straps or brackets may be provided to insure coupling to any type or style of muffler unit. The inlet end 102 preferably transitions through a curved section 114 which may be made of elbows or flexible tubing, then continues on to a more or less straight section 116, finally bending once again at 118 before terminating and outlet end 104. A strap, hook or other device 120 is provided on the outlet end 104 to hold it in position so that the hot exhaust gases are directed to the desired region of the compressor. Although a single length of flexible tubing may be used, more solid elbows may be preferred in some applications.

FIG. 2 is a more detailed drawing of the preferred embodiment, showing how brackets 112 may include holes 210 and/or slots 212 in separate pieces, allowing assembly of the brackets or straps to accommodate mufflers of different sizes and configurations. The preferred diameter of the tubing is 3 inches, though any size which would not create a backflow or resistance of the exhaust gas may be used.

At the outlet end, a hook or bent wire 120 is provided to hold the outlet end in position with respect to the regulator valve 136 connected to hose line 140, as shown in FIG. 3. The assembly is constructed of metal, such as galvanized steel, aluminum, and so forth, with the various components being held together with tack welding, sheet metal screws, or other appropriate fasteners.

Having described my invention, I claim:

1. For use in conjunction with a gas-powered air compressor having an air line with a regulator valve and a muffler with an exhaust port, apparatus for keeping the air line open during cold weather, comprising:
a length of tubing having an inlet end and an outlet end;
a plurality of length-adjustable brackets extending from the inlet end for coupling the tubing to a muffler such that the inlet end is aligned with the exhaust port; and
a bendable wire extending from the outlet end for maintaining the outlet end of the tubing directed toward an area of the compressor to prevent compressor component freezing.

2. The apparatus of claim 1, wherein the length of tubing includes a flexible section.

3. The apparatus of claim 1, wherein the length of tubing has a diameter on the order of 3 inches.

4. (canceled)

5. (canceled)
